(19) United States
(12) Patent Application Publication
(10) Pub. No.: US 2010/0064143 A1
(43) Pub. Date: Mar. 11, 2010

(54) SYSTEM LSI

(75) Inventor: Naoaki Ohkubo, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/556,890

(22) Filed: Sep. 10, 2009

(30) Foreign Application Priority Data
Sep. 11, 2008 (JP) 2008-233943

(51) Int. Cl. G06F 13/36; G06F 11/28; H04L 9/00

(52) U.S. Cl. 713/189; 710/305; 714/30; 714/E11.178

(57) ABSTRACT

A system LSI comprising: a processor which processes confidential data; a first on-chip bus which is connected to the processor; a working memory which saves the confidential data processed by the processor; and a memory interface circuit which is connected between the first on-chip bus and the working memory, and through which data is transferred between the working memory and the first on-chip bus under control of the processor.

### CROSS-REFERENCE TO RELATED APPLICATION

This application is based upon and claims the benefit of priority from the prior Japanese Patent Application No. 2008-233943 filed in Japan on Sep. 11, 2008, the entire contents of which are incorporated herein by reference.

### BACKGROUND OF THE INVENTION

1. Field of the Invention

The present invention relates to a system LSI for highly confidential processing.

2. Description of the Prior Art

In some system LSIs, depending on usage thereof, the operations of a processor and IPs (circuit modules for specific processes) within the system LSIs need to be concealed. Particularly, in a system LSI in which highly confidential processing such as an encryption-decryption process has to be performed, processing by a processor for performing such highly confidential processing needs to be prevented from being analyzed (see, Japanese Patent Application Publication No. 2002-358137, for example). Moreover, data that is used during highly confidential processing should also be handled cautiously. For example, conventional system LSIs that each include a dedicated encryption-decryption circuit in addition to a main processor have mainly two ways to handle confidential data such as an instruction code describing an algorithm for an encryption-decryption process and key data used for the encryption-decryption process. Specifically, such confidential data is saved in a local memory in the encryption-decryption circuit or in a general purpose memory of the system LSI, and then accessed by the main processor.

However, in the former case, the main processor will have access to the inside of the encryption-decryption circuit, which is not favorable in terms of security. Meanwhile, in the latter case where the confidential data is saved in the universal memory, any other circuit module can have access to the confidential data, resulting in a similar security problem. Furthermore, there is another problem that, in order to protect the confidential data used for an encryption-decryption process during debugging, some prevention scheme has to be made so that the process in the encryption-decryption circuit cannot be analyzed by a normal debugger.

### SUMMARY OF THE INVENTION

According to an aspect of the invention, there is provided a system LSI comprising: a processor which processes confidential data; a first on-chip bus which is connected to the processor; a working memory which saves the confidential data processed by the processor; and a memory interface circuit which is connected between the first on-chip bus and the working memory, and through which data is transferred between the working memory and the first on-chip bus under control of the processor.

According to an aspect of the invention, there is provided a system LSI comprising: a main processor; a main memory; a main bus which is connected to the main processor and to the main memory; a sub-processor which performs an encryption-decryption process on data; a working memory which saves confidential data created in the encryption-decryption process; a sub bus which is connected to the sub-processor; an interface circuit which is connected to the sub bus and to the working memory, and which prohibits or permits data transfer between the sub bus and the working memory under control of the sub-processor; and a bus bridge which is connected to the main bus and to the sub bus, and which controls data transfer between the main bus and the sub bus.

According to an aspect of the invention, there is provided a system LSI comprising: a main processor; a main bus which is connected to the main processor; a first debug interface circuit which is connected to the main bus, and to which a first debugger is connected during debugging of the main processor; a sub-processor which performs an encryption-decryption process on data; a sub bus which is connected to the sub-processor; a second debug interface circuit which is connected to the sub bus, and to which a second debugger is connected during debugging of the sub-processor; and a bus bridge which is connected to the main bus and to the sub bus, and through which data is transferred between the main bus and the sub bus under control of a debug mode signal outputted from the first debug interface circuit.

### BRIEF DESCRIPTION OF THE DRAWINGS

FIG. 1 is a circuit block diagram showing a system LSI according to an embodiment of the present invention.

FIG. 2 is a circuit block diagram for illustrating a method of controlling an SRAM-I/F in the system LSI according to the embodiment of the present invention.

FIG. 3 is a circuit block diagram for illustrating another method of controlling the SRAM-I/F in the system LSI according to the embodiment of the present invention.

FIG. 4 is a circuit block diagram for illustrating the control method during debugging in the system LSI according to the embodiment of the present invention.

FIG. 5 is a flowchart for illustrating the control method during debugging in the system LSI according to the embodiment of the present invention.

### DESCRIPTION OF THE PREFERRED EMBODIMENT

Hereinbelow, an embodiment of the present invention will be described with reference to the drawings.

### Embodiment

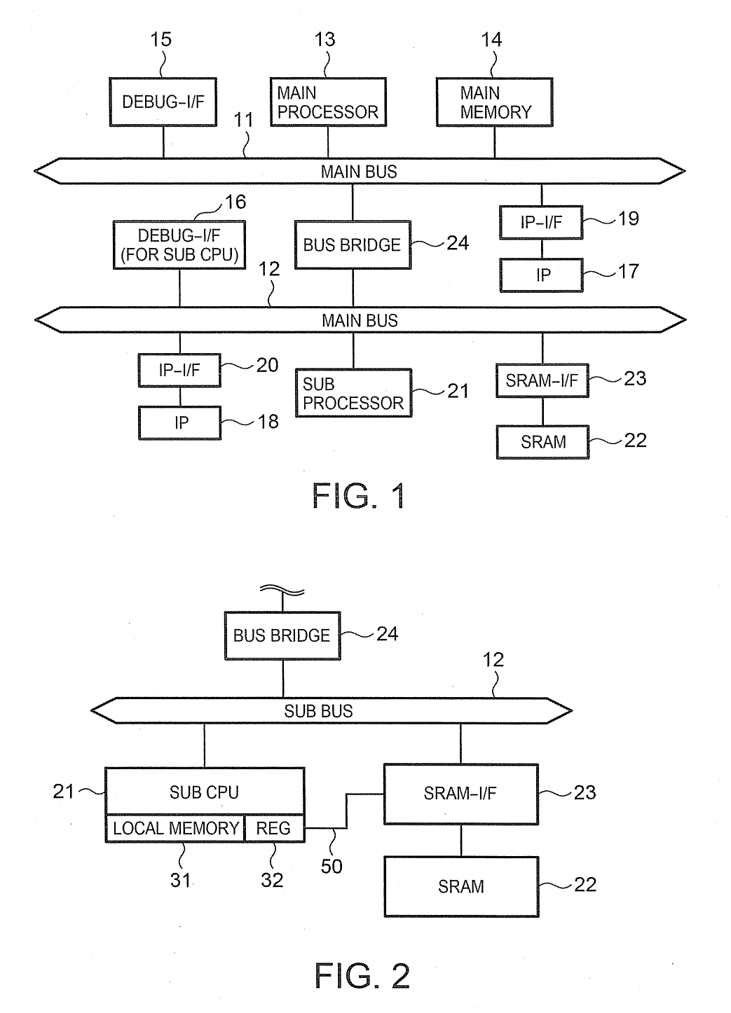

FIG. 1 is a circuit block diagram showing a system LSI according to the embodiment of the present invention. Here, mainly illustrated are portions that are involved in highly confidential processing such as an encryption-decryption process.

The system LSI according to the embodiment of the present invention includes a main bus 11 and a sub bus 12 which serve as on-chip buses (hereinbelow, the main bus 11 or the sub bus 12 may be referred to as “on-chip bus”), a main processor 13, a main memory 14, two debug interface circuits 15 and 16 (hereinbelow, referred to as “Debug-I/Fs 15 and 16”), two circuit modules 17 and 18 (hereinbelow, referred to as “IPs 17 and 18”) which perform a specific process, a module interface circuit 19 for the IP 17 (hereinbelow, referred to as “IP-I/F 19”), a module interface circuit 20 for the IP 18 (hereinbelow, referred to as “IP-I/F 20”), a sub-processor 21, a working memory 22, an interface circuit 23 for the working memory 22 (hereinbelow, referred to as “SRAM-I/F 23”), and a bus bridge 24 which connects the main bus 11 to the sub bus 12.

Each input and output of the main processor 13, the main memory 14 and the Debug-I/F 15 are connected to the main bus 11. An input and an output of the IP 17 are connected to first input and output of the IP-I/F 19. Second input and output of the IP-I/F 19 are connected to the main bus 11. First input and output of the bus bridge 24 are connected to the main bus 11.

An input and an output of the sub-processor 21 are connected to the sub bus 12. An input and an output of the working memory 22 are connected to first input and output of the SRAM-I/F 23. Second input and output of the SPAM-I/F 23 are connected to the sub bus 12. An input and an output of the Debug-I/F 16 are connected to the sub bus 12. An input and an output of the IP 18 are connected to first input and output of the IP-I/F 20. Second input and output of the IP-I/F 20 are connected to the sub bus 12. Second input and output of the bus bridge 24 are connected to the sub bus 12.

The Debug-I/F 15 is an interface circuit to which a debugger typified by an In Circuit Emulator (ICE) is connected when most part of the system LSI is debugged.

The Debug-I/F 16 is an interface circuit connected to a dedicated ICE used for debugging the sub-processor 21.

The IP-I/Fs 19, 20 are interface circuits which respectively connect the IPs 17, 18 to the corresponding on-chip buses. The IP-I/Fs 19, 20 are allowed to cut off the connection between the on-chip buses and the IPs 17, 18 during debugging, as necessary. The detail of controlling the IP-I/Fs 19, 20 will be described below using FIG. 4.

The sub-processor 21 is a dedicated processor for performing highly confidential processing such as an encryption-decryption process.

The working memory 22 is a dedicated memory used when the sub-processor 21 performs an encryption-decryption process or the like. An SRAM is used as the working memory 22.

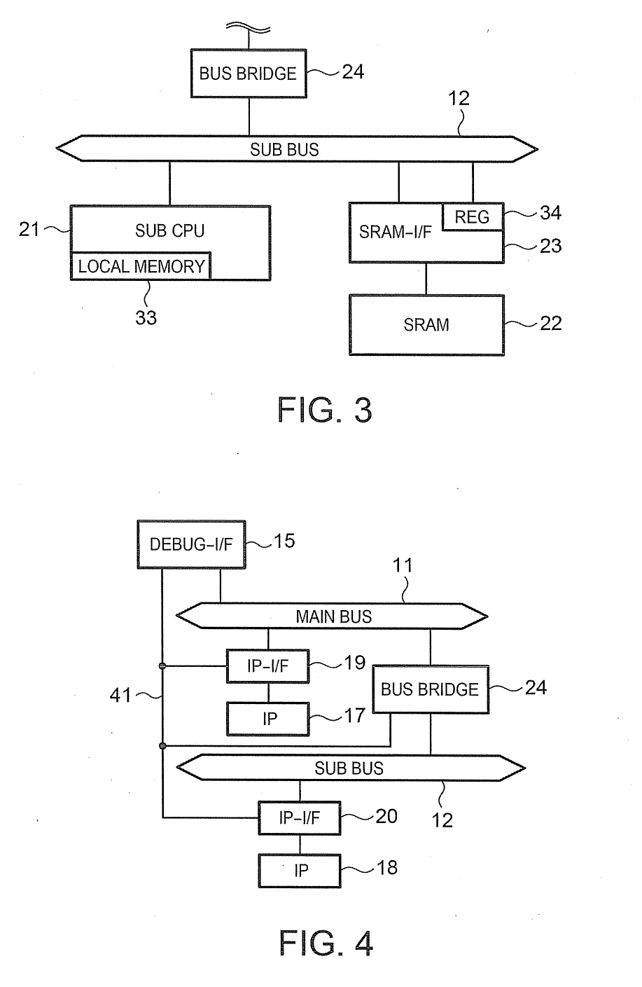

The SRAM-I/F 23 is an interface circuit which connects the working memory 22 to the sub bus 12. The SRAM-I/F 23 is allowed to cut off the connection between the working memory 22 and the sub bus 12 as necessary. The detail of controlling the SRAM-I/F 23 will be described below using FIGS. 2 and 3.

The bus bridge 24 is a circuit which changes protocols and transfers data between the main bus 11 and the sub bus 12. The bus bridge 24 is allowed to cut off the connection between the main bus 11 and the sub bus 12 during debugging, as necessary. The detail of controlling the bus bridge 24 will be described below using FIG. 4.

FIG. 2 is a circuit block diagram for illustrating a method of controlling the SRAM-I/F 23 in the system LSI according to embodiment of the present invention.

As shown in FIG. 2, the sub-processor 21 includes: a local memory 31 for storing data processed within the sub-processor 21; and a control register 32 for controlling the SRAM-I/F 23. The SRAM-I/F 23 and the control register 32 are directly connected to each other with a wiring 50.

FIG. 3 is a circuit block diagram for illustrating another method of controlling the SRAM-I/F 23 in the system LSI according to the embodiment of the present invention.

As shown in FIG. 3, in this control method, the sub-processor 21 includes a local memory 33 for storing data processed in the sub-processor 21, and the SRAM-I/F 23 includes a control register 34 for controlling the SRAM-I/F 23.

FIG. 4 is a circuit block diagram for illustrating the control method during debugging in the system LSI according to the embodiment of the present invention.

As shown in FIG. 4, the output of the Debug-I/F 15 is connected, for transmitting a debug mode signal 41, to each of the input of the IP-I/F 19, the input of the IP-I/F 20, and the input of the bus bridge 24. During debugging, the debug mode signal 41 cuts off each connection between the IP 17 and the main bus 11, between the IP 18 and the sub bus 12, and between the main bus 11 and the sub bus 12, as necessary.

Next, operations of the system LSI having the above-described configuration will be described.

First, description will be given of a data concealing method using the sub-processor 21 for the encryption-decryption process.

The sub-processor 21 receives, through the sub bus 12 and the bus bridge 24, an encryption-decryption process command from the main processor 13. To acquire encryption data for the encryption-decryption process, the sub-processor 21 accesses the main memory 14 via the bus bridge 24.

The encryption data is written into the local memory 31 or 33 of the sub-processor 21 via the bus bridge 24. Since the inside of the sub-processor 21 is inaccessible to the other modules in the present system LSI, the decryption process is performed within the sub-processor 21, and the decrypted confidential data is written into the working memory 22 via the sub bus 12.

The confidential data created during the encryption-decryption process is saved in the working memory 22. At this time, in order to prohibit the modules other than the sub-processor 21 from accessing the confidential data, the sub-processor 21 has a function to set either the control register 32 or 34 for controlling the SRAM-I/F 23. Note that the modules other than the sub-processor 21 cannot set the values for the registers 32, 34.

When acquiring already-processed confidential data, the main processor 13 sends the sub-processor 21, via the bus bridge 24, a specific command instructing to open the SRAM-I/F 23.

Upon receipt of the specific command, the sub-processor 21 writes an access permission value into the control register 32 which the sub-processor 21 includes as shown in FIG. 2. Thereby, the SRAM-I/F 23 is opened, allowing the access to the working memory 22.

Alternatively, upon receipt of the specific command, the sub-processor 21 writes an access permission value into the control register 34 of the SRAM-I/F 23 shown in FIG. 3 via the sub bus 12. Thereby, the SRAM-I/F 23 is opened, allowing the access to the working memory 22.

In the former control method, the SRAM-I/F 23 is controlled only by the sub-processor 21, and the control register 32 is never seen from the outside. Thus, this method is safe.

In the latter control method, the sub-processor 21 and the SRAM-I/F 23 are not wire-connected, and thus are mountable as separate modules that do not depend on each other. Moreover, either by undisclosing the specification of the control register 34, or by setting a special procedure for accessing the control register 34, the access to the control register 34 by the modules other than the sub-processor 21 is limited.

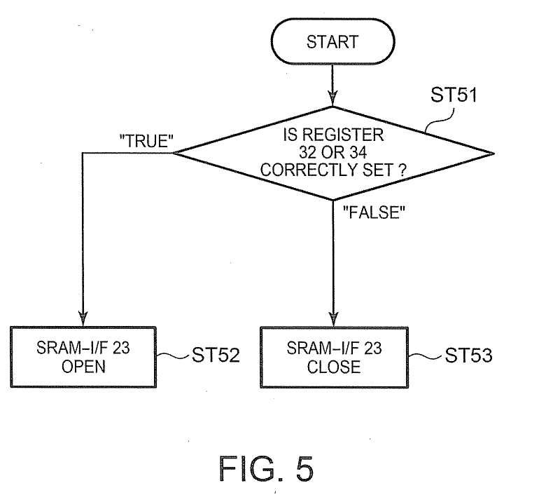

As a result, as shown in FIG. 5, when the control register 32 or 34 is correctly set (ST51) (“true”), the SRAM-I/F 23 is opened (ST52), and the data path from the main processor 13 to the working memory 22 is enabled. In other words, the main processor 13 becomes accessible to the confidential data via the SRAM-I/F 23.

If both the control registers 32 and 34 are not correctly set (“false”), the SRAM-I/F 23 remains closed (ST53), the main processor 13 is inaccessible to the working memory 22.

After the processing on the confidential data by the main processor 13 is completed, in order to limit the access to the SRAM-I/F 23 again, the main processor 13 sends the sub-processor 21 a specific command to control the SRAM-I/F 23. Upon receipt of the specific command, the sub-processor 21 initializes the control register 32 or 34 to thus limit the access to the working memory 22 again.

Next, the operations during debugging will be described.

The modules other than the sub-processor 21 are debugged by using the Debug-I/F 15 connected to the main bus 11.

Methods of concealing operations of each circuit during debugging are roughly classified into two categories: a method in which operations of each IP are concealed; and a method in which operations of each bus connected to the bus bridge 24 are concealed. When operations of the IP 17 and the IP 18 are to be concealed during debugging, the IP-I/F 19 and the IP-I/F 20 which respectively connect the IPs to the corresponding on-chip buses are controlled by using a debug mode signal 41 from the Debug-I/F 15 to thereby limit the access to each IP.

Now, described is the case where operations of each bus are concealed; for example, where all the modules connected to the sub bus 12 are to be concealed by controlling the bus bridge 24. In this case, when a debugger (ICE or the like) is connected to the Debug-I/F 15, the bus bridge 24 is controlled by using a debug mode signal 41 from the Debug-I/F 15.

Specifically, the bus bridge 24 makes the sub bus 12 inaccessible. Thereby, the debugger connected to the Debug-I/F 15 cannot access the IP 18, the sub-processor 21, and the working memory 22, which are connected to the sub bus 12.

Thus, when the sub-processor 21 for performing an encryption-decryption process performs a process, the debugger connected to the Debug-I/F 15 cannot access data transferred between the sub-processor 21 and the working memory 22. Accordingly, confidential data which the sub-processor 21 works on is concealed during debugging.

On the other hand, the sub-processor 21 is debugged by using the Debug-I/F 16 connected to the sub bus 12, the Debug-I/F 16 being connected to a debugger dedicated to the sub-processor 21. Accordingly, the sub-processor 21 is prevented from being analyzed by a normal debugger connected to the Debug-I/F 15.

As has been described, with the dedicated working memory 22 which holds confidential data used in an encryption-decryption process and with the SRAM-I/F 23 provided between the sub bus 12 and the working memory 22, only the sub-processor 21 is allowed to control the SRAM-I/F 23. By such a control, the other modules can access the confidential data held in the working memory 22 only when the permission is given by the sub-processor 21 which performs the encryption-decryption process. This helps to avoid a risk resulting from confidential data written into the main memory 14, and the confidential data held in the working memory 22 is protected.

Moreover, the above-described configuration eliminates the necessity of the main processor 13 to access the inside of the sub-processor 21. Thus, the sub-processor 21 can be designed as a module which inside is inaccessible to the other modules, improving safety when highly confidential processing such as an encryption-decryption process is performed.

Furthermore, when the Debug-I/F 15 is debugged after a debugger is connected thereto, the debug mode signal 41 outputted from the Debug-I/F 15 is used to control the IP-I/F 19 and the IP-I/F 20 for controlling the accesses to the IP 17 and the IP 18 as well as to control the bus bridge 24 that connects the main bus 11 to the sub bus 12. Thereby, processing of each IP is concealed during debug operations. Moreover, operations and data of the modules connected to each bus, for example, the sub bus 12 are concealed.

According to the embodiment described above, highly confidential instruction codes and data are concealed, and thus a high-security system LSI is fabricated.

Moreover, according to the embodiment, data access to and debugging of the working memory 22 that holds confidential data used in the encryption-decryption process or the like are performed safely.

Furthermore, according to the embodiment, processing and data of each IP (circuit module) to be concealed are protected during debugging.

Still furthermore, according to the embodiment, data used in operations and processing of IPs and processors for confidential processing for each on-chip bus are concealed during debugging.

Having described the embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A system LSI comprising:
a processor which processes confidential data;
a first on-chip bus which is connected to the processor;
a working memory which saves the confidential data processed by the processor; and
a memory interface circuit which is connected between the first on-chip bus and the working memory, and through which data is transferred between the working memory and the first on-chip bus under control of the processor.

2. The system LSI according to claim 1, wherein
the processor includes a control register for controlling the memory interface circuit, and
a signal for controlling the memory interface circuit is transmitted through a wire which directly connects the control register to the memory interface circuit.

3. The system LSI according to claim 1, wherein
the memory interface circuit includes a control register for controlling the data transfer between the working memory and the first on-chip bus, and
a value in the control register is set by the processor.

4. The system LSI according to claim 1, further comprising:
a debug interface circuit to which a debugger is connected during debugging;
a second on-chip bus which is connected to the debug interface circuit; and
a bus bridge which connects the first on-chip bus to the second on-chip bus, wherein
data is transferred through the bus bridge under control of a debug mode signal from the debug interface circuit.

5. The system LSI according to claim 4, further comprising:
a circuit module which performs a specific process; and
a module interface circuit which is connected between the circuit module and any one of the first on-chip bus and the second on-chip bus, and through which data is transferred between the circuit module and any one of the first on-chip bus and the second on-chip bus under control of the debug mode signal.

6. A system LSI comprising:
a main processor;
a main memory;
a main bus which is connected to the main processor and to the main memory;
a sub-processor which performs an encryption-decryption process on data;
a working memory which saves confidential data created in the encryption-decryption process;
a sub bus which is connected to the sub-processor;
an interface circuit which is connected to the sub bus and to the working memory, and which prohibits or permits data transfer between the sub bus and the working memory under control of the sub-processor; and
a bus bridge which is connected to the main bus and to the sub bus, and which controls data transfer between the main bus and the sub bus.

7. The system LSI according to claim 6, wherein
the main processor sends the sub-processor an encryption-decryption process command, and
upon receipt of the encryption-decryption process command, the sub-processor acquires data stored in the main memory, and performs the encryption-decryption process on the data.

8. The system LSI according to claim 6, wherein
the main processor sends the sub-processor an access request command for requesting access to the working memory, and
upon receipt of the access request command, the sub-processor controls the interface circuit, allowing the main processor to access the working memory.

9. The system LSI according to claim 6, wherein
the sub-processor includes a local memory therein, and
the local memory is inaccessible from outside of the sub-processor.

10. The system LSI according to claim 6, wherein
the sub-processor includes a register therein,
the interface circuit prohibits or permits the data transfer between the sub bus and the working memory in accordance with a value written in the register.

11. The system LSI according to claim 10, further comprising
a wiring which directly connects the register to the interface circuit.

12. The system LSI according to claim 6, wherein
the interface circuit includes a register in which the sub-processor is allowed to write a value, and
the interface circuit prohibits or permits the data transfer between the sub bus and the working memory in accordance with the value written in the register.

13. A system LSI comprising:
a main processor;
a main bus which is connected to the main processor;
a first debug interface circuit which is connected to the main bus, and to which a first debugger is connected during debugging of the main processor;
a sub-processor which performs an encryption-decryption process on data;
a sub bus which is connected to the sub-processor;
a second debug interface circuit which is connected to the sub bus, and to which a second debugger is connected during debugging of the sub-processor; and
a bus bridge which is connected to the main bus and to the sub bus, and through which data is transferred between the main bus and the sub bus under control of a debug mode signal outputted from the first debug interface circuit.

14. The system LSI according to claim 13, further comprising
a first circuit module which is connected to the main bus, wherein
the first debug interface circuit is connected to the first debugger during debugging of the first circuit module, also.

15. The system LSI according to claim 14, further comprising
a first module interface circuit which is connected between the main bus and the first circuit module, wherein
the first module interface circuit prohibits data transfer between the main bus and the first circuit module under control of the debug mode signal.

16. The system LSI according to claim 13, further comprising
a second circuit module which is connected to the sub bus, wherein
the first debug interface circuit is connected to the first debugger during debugging of the second circuit module, also.

17. The system LSI according to claim 16, further comprising
a second module interface circuit which is connected between the sub bus and the second circuit module, wherein
the second module interface circuit prohibits data transfer between the sub bus and the second circuit module under control of the debug mode signal.
